(19) United States
(12) Patent Application Publication
(10) Pub. No.: US 2003/0093243 A1
(43) Pub. Date: May 15, 2003

(54) Invention for use in rating performance and monitoring product development

(76) Inventors: Scott Kusch, Macomb, MI (US); Rebecca Snyder, South Lyon, MI (US); Vince Paul Cassar, Dearborn Heights, MI (US); Chet Kapla, Plymouth, MI (US); John Haldane JR., Northville, MI (US); Timothy C. Dowdell, South Lyon, MI (US); Brian Lee Dunlavy, Canton, MI (US)

Correspondence Address: BROOKS & KUSHMAN P.C./FGTI, 1000 TOWN CENTER, 22ND FLOOR, SOUTHFIELD, MI, 48075, US

(21) Appl. No.: 10/285,253

(22) Filed: Oct. 31, 2002

Related U.S. Application Data
(60) Provisional application No. 60/335,223, filed on Oct. 31, 2001.

(51) Int. Cl. G06F 15/00; G06F 11/30

(52) U.S. Cl. 702/182

(57) ABSTRACT

An invention for use in rating performance and monitoring product development. The method includes providing an element rating checklist that includes a number of product development milestones for an element. The checklist includes ratable expectations that correspond to product development milestones for use in rating supplier performance and monitoring product development.

### CROSS-REFERENCE TO RELATED APPLICATIONS

This application claims the benefit of U.S. provisional application Serial No. 60/335,223, filed Oct. 31, 2001.

### BACKGROUND OF THE INVENTION

1. Field of the Invention

The present invention relates to monitoring product development. In particular, the present invention relates to the use of Advanced Product Quality Planning (APQP) for monitoring key elements of product development.

2. Background Art

Product development relates to a life cycle for use with designing, developing, and manufacturing a product. Especially for automobile manufacturers, product development is a difficult and time consuming process. The Automotive Industry Action Group (AIAG) developed Advanced Product Quality Planning (APQP) in an attempt to simplify the product development process. One example of the APQP process is disclosed in “Advanced Product Quality Planning (APQP) and Control Plan, Reference Manual,” 1995, Chrysler Corporation, Ford Motor Company, and General Motors.

Chrysler, Ford, and General Motors each have their own guidelines and formats for product development. The AIAG developed and distributed the APQP manual in an attempt to standardize these different product development processes for automotive suppliers. The APQP guidelines detail a number of key elements of product development for designing, developing, and manufacturing a product. The key elements are referred to as APQP elements and are explained with the aid of a number of plans and checklists for each APQP element. The manual, however, does not provide detailed instructions for completing the plans and checklists for each APQP element. In addition, the lack of detail makes it difficult to rate performance and monitor product development.

### SUMMARY OF THE INVENTION

One aspect of the present invention relates to a computer-implemented method for monitoring product development. The method includes providing an element rating checklist that includes a number of expectations and a number of product development milestones with each expectation corresponding to a product development milestone. In addition, the method includes receiving an expectation rating for each expectation and computating a milestone rating for each product development milestone based in part on the received expectation ratings, the milestone ratings for use in rating performance and monitoring product development.

Another aspect of the present invention relates to a computer-readable medium for monitoring product development. The computer-readable medium includes instructions for storing an element rating checklist thereon that includes a number of expectations and a number of product development milestones with each expectation corresponding to a product development milestone. In addition, the computer readable medium includes instructions for receiving an expectation rating for each expectation and computating a milestone rating for each product development milestone based in part on the received expectation ratings, the milestone ratings for use in rating performance and monitoring product development.

Yet another aspect of the present invention relates to a system for monitoring product development. The system includes computer means for providing an element ratings checklist that includes a number of expectations and a number of product development milestones with each expectation corresponding to a product development milestone. In addition, the method includes computer means for receiving an expectation rating for each expectation and computating a milestone rating for each product development milestone based in part on the received expectation ratings, the milestone ratings for use in rating performance and monitoring product development.

### BRIEF DESCRIPTION OF THE DRAWINGS

FIG. 1 illustrates a system for use in monitoring product development, in accordance with the present invention;

FIG. 2 illustrates a checklist for use in monitoring product development, in accordance with the present invention;

FIG. 3 illustrates an optional status report for use in monitoring product development, in accordance with the present invention;

FIG. 4a illustrates a first portion of an exemplary checklist for use in monitoring product development, in accordance with the present invention;

FIG. 4b illustrates a second portion of the exemplary checklist shown in FIG. 4a, in accordance with the present invention; and

FIG. 5 illustrates an exemplary status report for use in monitoring product development, in accordance with the present invention.

### DETAILED DESCRIPTION OF THE PREFERRED EMBODIMENT

As described in the background section, the known manual includes a number of elements that broadly describe key elements for product development that have been developed to standardize product development. The present invention provides the supplier with detailed missions and tasks for each element and an ability to rate the supplier's performance in completing the missions and tasks for monitoring product development.

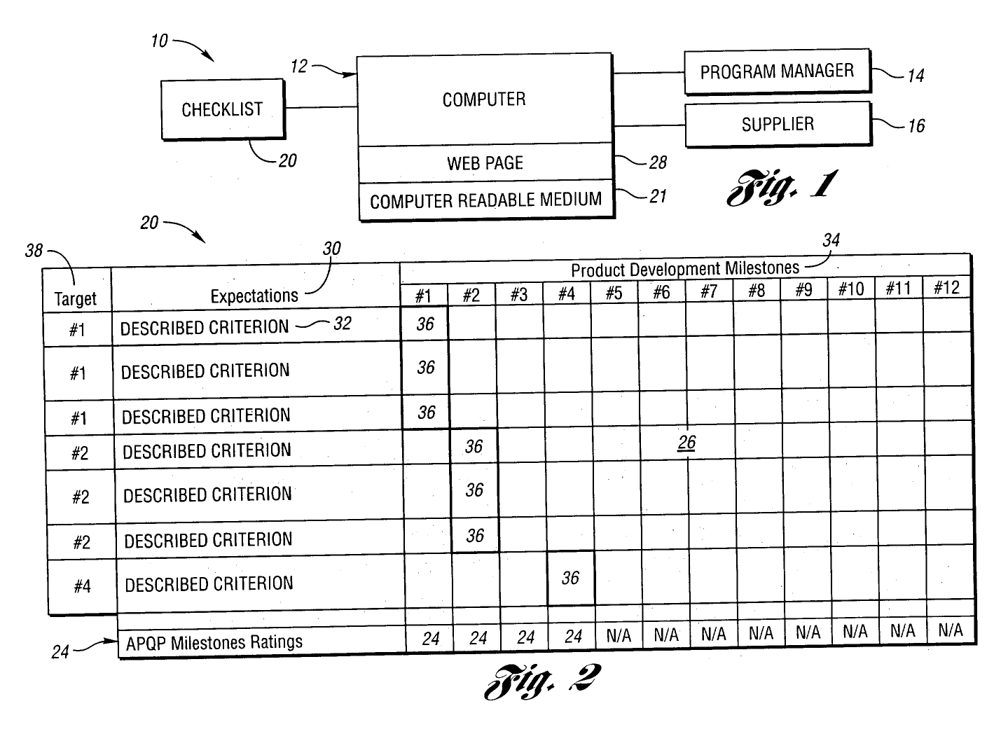

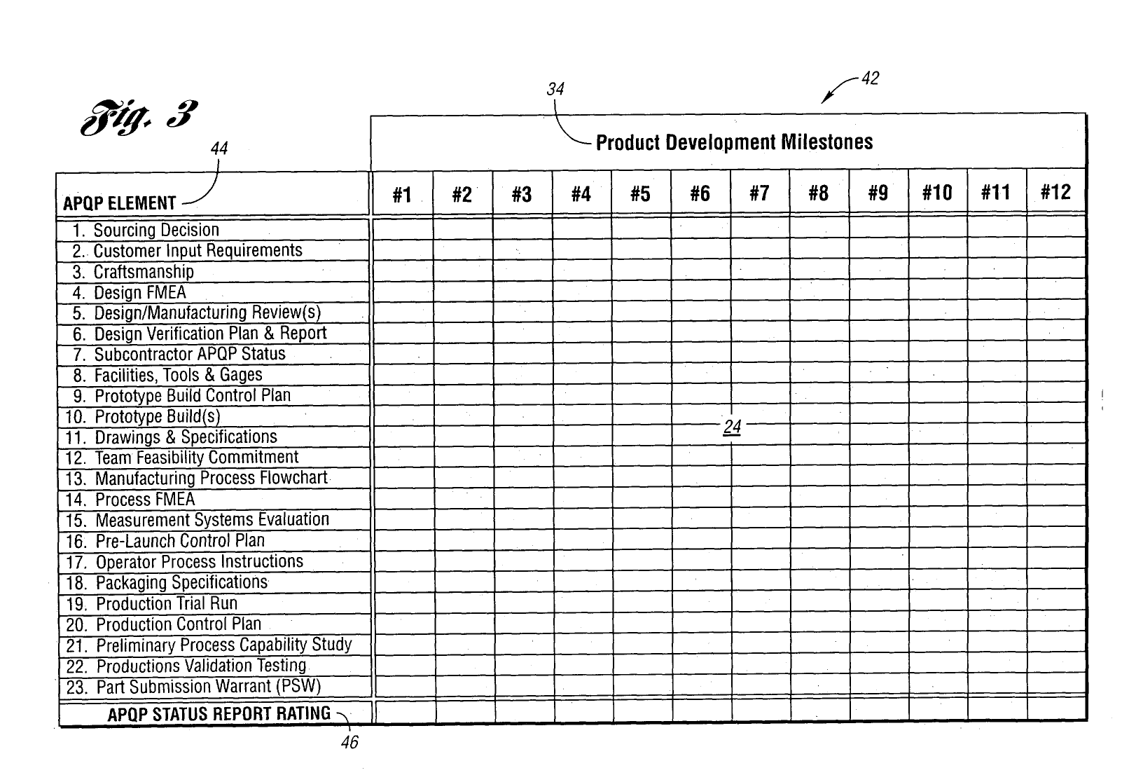

FIG. 1 illustrates a system 10 for monitoring product development. The system 10 includes a computer 12 for monitoring product development in a manner that allows a program manager 14 and a supplier 16 to rate supplier performance for use in rating performance and monitoring product development. In particular, the computer 12 includes a computer readable medium 20, such as memory, having instructions for providing an element rating checklist 21 for use in determining milestone ratings 24, the checklist 22 is shown in FIG. 2.

The computer 12 provides a separate checklist 20, or other element having the checklist 20 stored thereon, for each element. The checklist 20 shown is a computer spreadsheet having a number of computer cells 26. It is within the scope and contemplation of this invention, however, to replace the computer 12 and the computer spreadsheet with other computer means, such as a web page 28, a computer server, a software program or code, and other medium.

The checklist 20 includes a number of expectations 30 that define a number of missions and tasks the supplier 16 should complete for a particular element. The expectations 30 are arranged in rows and include described criterion 32 that is derived according to the element that the checklist is assigned to. As each element only describes a broad aspect of product development, the checklist 20 is advantageous in that it provides the supplier 16 with a number of detailed expectations 30 for completing elements. By breaking down each element, or at least the relevant elements, the present invention provides meaningful missions and tasks that the supplier 16 can easily understand and that can be used to rate supplier performance in a meaningful manner for monitoring product development.

The checklist 20 includes product development milestones 34 that correspond with the expectations 30 to provide the supplier 16 with a timing guide that can be used throughout product development to determine when each expectation 30 should be completed. The product development milestones 34 relate to measurement points or events in product development that are advantageous for monitoring product development. As shown, each column of computer cells 26 define an individual product development milestone 34 that are labeled #1 through #12. The same product development milestones 34 are used for each checklist 20 so that a standard life cycle is used to monitor product development.

Expectation ratings 36 are determined based on the supplier's ability to complete an expectation 30 by a corresponding product development milestone 34. The expectation ratings 26 are determined by the supplier 16 or the program manager 14 submitting expectation ratings 36 through a web page 28, file exchange, or other medium for receipt by to the checklist 20. If a cell 26 does not receive an expectation rating 36, the expectation rating 36 is determined to be not applicable or blank. An outlined box or a target cell 38 indicates the corresponding product development milestone 34 due date for an expectation 30.

The program manager 14 usually requests the supplier 16 to submit expectations ratings 36 each fiscal quarter. Expectations ratings 36 should be submitted for all the expectations 30, even if the assigned product development milestone 34 due date occurs before or after the time that the ratings 36 are submitted. A red, yellow, or green expectation rating 36 can be used.

An “R” designates red and represents a high risk when expectations 30 are not completed, or likely to be completed, by the assigned product development milestone 34 and the supplier 16 has not determined a corrective action work plan to complete the expectation 30. A “Y” designates yellow and represents a moderate risk when expectations 30 are not completed, or likely to be completed, by the assigned product development milestone 34 and the supplier 16 has implemented and gained approval of a corrective action work plan to complete the expectation 30. A “G” indicates green and low risk when expectations 30 are completed, or likely to be completed, by the assigned product development milestone 34.

If the supplier 16 has completed, or is likely to complete, an expectation 30 by the assigned product development milestone 34, then the expectation rating 36 is green. If the supplier 16 has not, or is not likely to, complete the expectation 30 by the assigned product development milestone 34, then the expectation rating 36 is either yellow or red. Expectation ratings 36 can be determined beyond the corresponding product development milestone 34 if the supplier 16 or program manager 14 submits a later expectation rating 36 for the expectation 30 for a later product development milestone 34. Expectations ratings 36 can also be determined prior to the due date for the expectation 30 if the supplier 16 or program manager 14 submits an earlier expectation rating 36 for the expectation 30 for an earlier product development milestone 34. The earlier and later operation ratings 36 can help rating performance because it is desirable to know as soon as possible when problems have occurred, as referenced to with the earlier expectation ratings, and when the problems will likely be corrected, as referenced to with the later expectation ratings.

The supplier's overall performance in completing one or more expectations 30 that are due at a particular product development milestone 34 is reflected by the milestone ratings 24. The milestone ratings 24 are determined by the supplier 16 or program manager 14 reviewing and analyzing all received expectation ratings 36 for a particular product development milestone 34 and computating or calculating a milestone rating 24 that reflects the supplier's performance in completing all the expectations 30 that are due for the particular product development milestone 34. In addition, the computer 12 could computate or calculate the milestone rating 24 as the lowest one, or some other factor, of the expectation ratings 36 for a particular product development milestone 34. For product development milestones 34 that do not receive an expectation rating 36, a not applicable symbol or a blank cell is computated and considered as the milestone rating 24. The milestone ratings 24 can be the same red, yellow, and green ratings used for the expectation ratings 36.

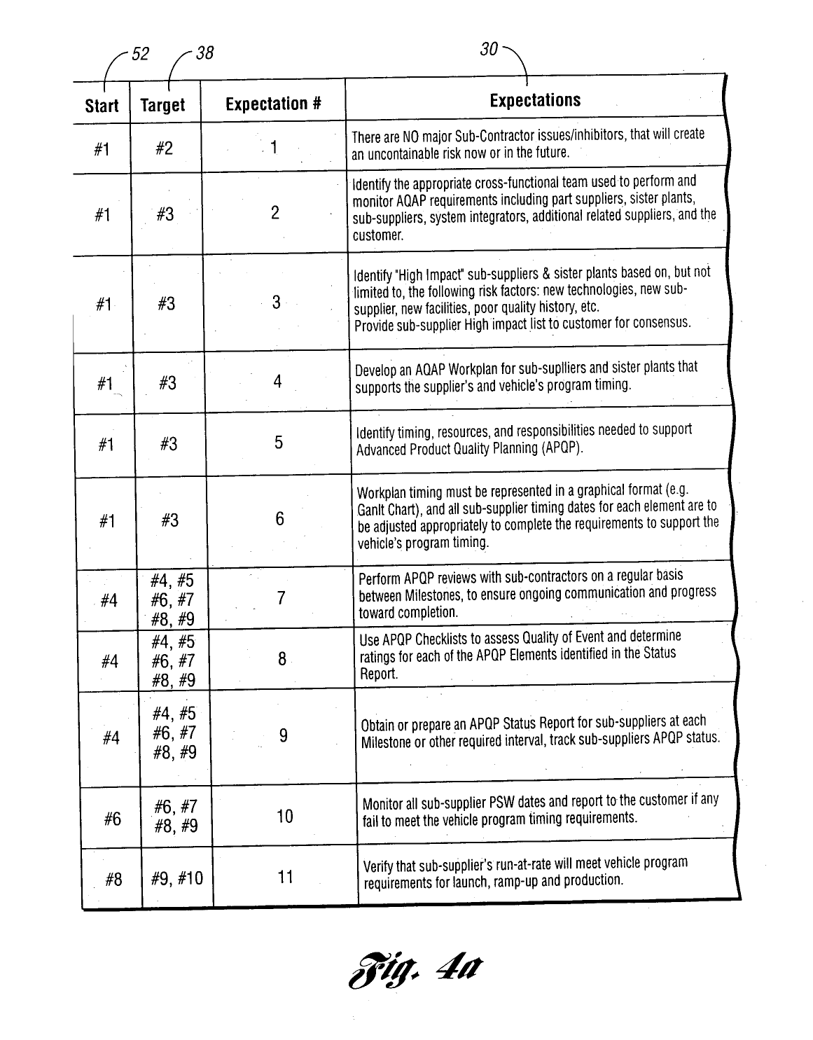

FIG. 3 illustrates an optional status report 42 that the computer 12 can generate by compiling the milestone ratings 24 for each element 44 into a single reviewable document. As shown, there are 23 elements 44. The AIAG developed 19 elements that include: design failure mode equipment analysis (FMEA); design verification plan and report; prototype build control plan; manufacturing process flow chart; process FMEA; pre-launch control plan; operation process instruction; production control plan; design and manufacturing review; facilities/tools/gauges; prototype build; drawings and specification; team feasibility commitment; measurement systems evaluation; packaging specification; production trial run; preliminary process capability study; production validation testing; and part submission warrant (PSW). In addition to the 19 elements developed by the AIAG, the present invention includes four other elements. The four elements include Sourcing, Customer Input Requirements, Craftsmanship, and Subcontractor Status. Sourcing, Customer Input Requirements, and Craftsmanship ensure that early up front analysis of the customer requirements are completed appropriately, and sourcing of the program suppliers are done in a timely manner to help ensure the supplier's expectations on time. Subcontractor Status is related to the submission of supplier status reports.

The status report 42 can be used to summarize performance by determining status report ratings 46 based on the milestone ratings 24 for each product development milestone 34. The status report ratings 46 are determined by the supplier 16 or the program manager 14 reviewing and analyzing all the determined milestone ratings 24 for each rated element 44 in a particular product development milestone 34 and computating or calculating a status report rating 46 that reflects performance for that milestone 34. In addition, the computer 12 could computate or calculate the status report rating 46 as the lowest one, or some other factor, of the milestone ratings 24 for a particular product development milestone 34. The status report 42 summarizes on a broader scale than the checklist 20 as the status report ratings 46 reflect performance for all the elements 44 at each product development milestone 34, and not for a single element, like the checklist 20. The status reports and status ratings are particularly advantageous for managing large product development programs that may include a number of suppliers providing products for assembly with other supplier developed products.

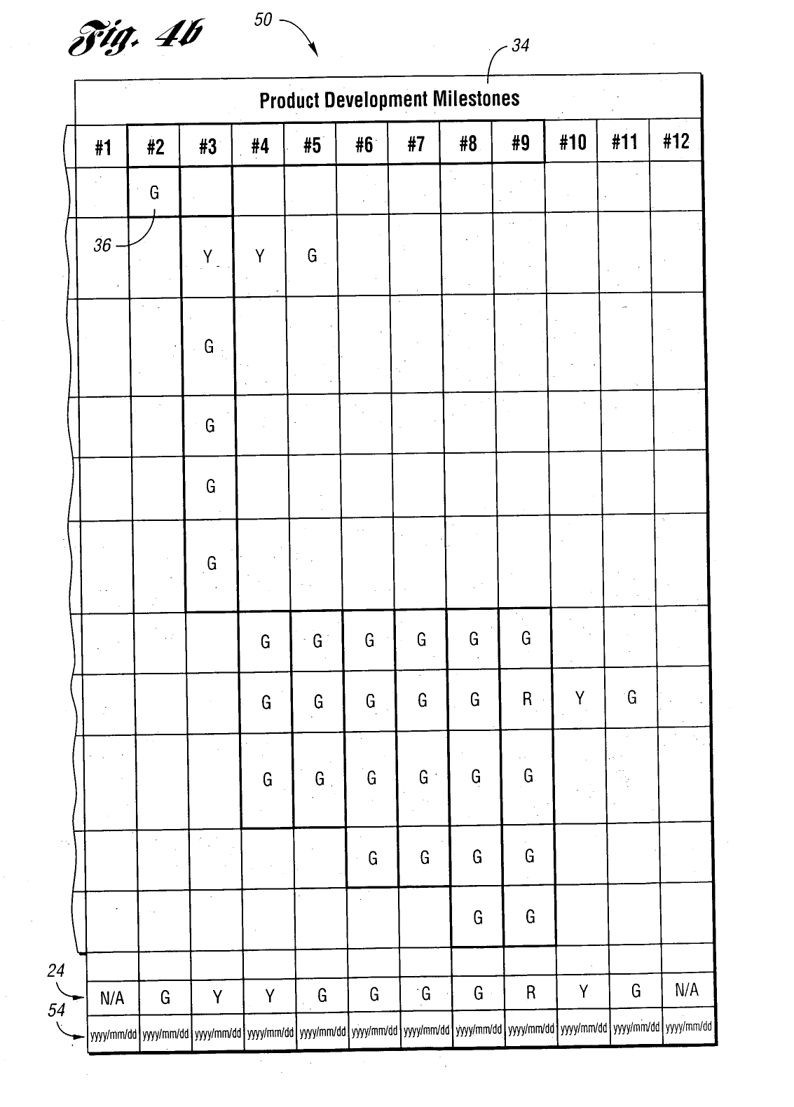

FIG. 4 illustrates an example of a checklist 50 assigned to the element 44 for subcontractor status. Like any checklist of the present invention, the subcontractor status checklist 40 defines a number of expectations 30 that should be completed by a specified product development milestone 34. The product development milestones 34 are shown with a descriptive label and refer to 12 portions of the product development life cycle. The product development milestones 34 are user defined periods that could be selected for or defined for any other interval.

As shown, there are 11 expectations 30 for subcontractor status. Expectation #1 requires the supplier to determine that there are no major subcontractor 3b issues/inhibitors that will create an uncontainable risk now or in the foreseeable future by product development milestone #2. A green expectation rating 36 was determined to show that the supplier 16 has, or is likely to, complete the expectation #2 by product development milestone #2. For expectation #7, the supplier 16 needs to perform reviews with subcontractors a number of times for product development milestones #4, #5; #6, #7, #8, and #9. There are any number of other user defined expectations 30 that could be used. The expectations 30 shown detail some examples of different expectations 30 and each checklist 20 could include more or less expectations 30 and other corresponding intervals for the milestones 34.

Once the expectation ratings 36 are determined for each expectation 30, the milestone ratings 24 are determined from the determined expectation ratings 26. For example, the milestone rating 24 for product development milestone #4 is yellow and determined by considering the expectation ratings 36 for expectations #2, #7, #8, and #9. In this case, the computer 12 determined the milestone rating 24 based on a computer readable medium 21 in the computer having instructions-for providing the checklist 50 and determining the milestone ratings 24 as the lowest considered expectation rating 36. The computer 12 could weight the received expectation ratings 36 or apply other algorithms for determining the milestone ratings 24. In addition, the supplier 16 or program manager 14 could subjectively determine the milestone ratings 24.

In addition to the foregoing features, the checklist 50 can also include additional features. In particular, the checklist 50 can include start milestones 52 that tell the supplier 16 when to begin performing one of the expectations 30. The checklist 50 can include calendar dates 54 for detailing the calendar due date for each product development milestones 34. Other features, that are not shown but within the contemplation and scope of the present invention, include features for allowing the incorporation of comments and details regarding corrective work plans, and others.

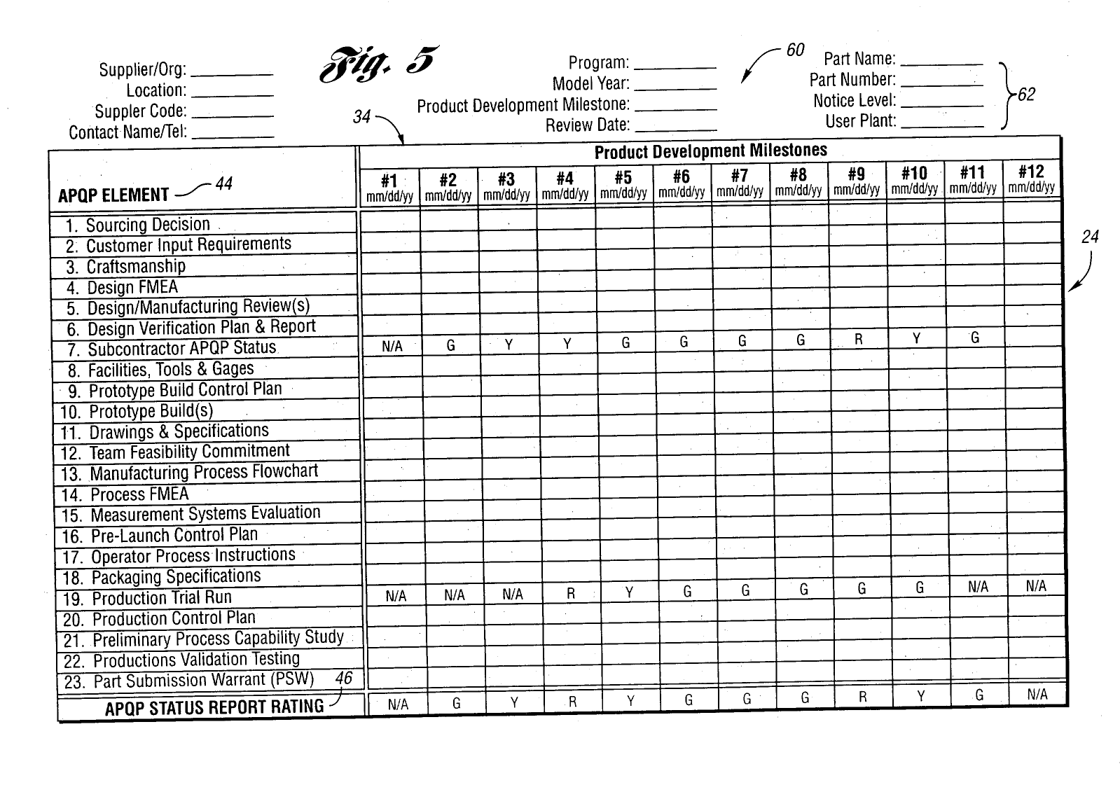

FIG. 5 illustrates a status report 60 that includes the milestone ratings 24 determined for the subcontractor status checklist 50 shown in FIG. 4 and product trial run. In addition, the status report 60 shows status ratings 46. The status ratings 46 are based on the milestone ratings 24 for each product development milestone 34. The status report 60 can include a number of descriptive fields 62. For example, the status report may include fields related to: supplier or organization; location; supplier code; contact name; telephone number; program; model year; product development milestone; review date; part number; part name; notice level; and user plan. In addition, other fields contemplated but now shown include: element activity; issues for red/yellow elements; corrective action and resolution plan; timing; and responsibility. The information for these fields is received by the computer in a manner similar to the way in which the expectation ratings are received by the computer.

While the best mode for carrying out the invention has been described in detail, those familiar with the art to which this invention relates will recognize various alternative designs and embodiments for practicing the invention as defined by the following claims.

What is claimed:

1. A computer-implemented method for monitoring product development, the method comprising:
providing an element ratings checklist having a number of expectations and a number of product development milestones, each expectation corresponding to a product development milestone;
receiving an expectation rating for each expectation; and
computating a milestone rating for each product development milestone based in part on the received expectation ratings, the milestone ratings for use in rating performance and monitoring product development.

2. The method of claim 1 further comprising generating a status report having the computated milestone ratings for use in rating performance and monitoring product development.

3. The method of claim 2 further comprising computating a status report rating for each product development milestone based on the computated milestone ratings and including the status report ratings with the status report.

4. The method of claim 3 wherein the expectation ratings are either red, yellow, or green designations that reflect performance, wherein red reflects a-high risk, yellow reflects a moderate risk, and-green reflects a low risk.

5. The method of claim 4 wherein the computer includes a computer readable memory having the checklist stored thereon and instructions for computating the milestone ratings and the status report ratings.

6. The method of claim 6 wherein the checklist and the status report are accessible for reviewing and editing through a web page.

7. The method of claim 6 further comprising:
providing multiple element rating checklists for a number of elements;
computating milestone ratings for each checklist based in part on received expectation ratings;
generating a status report having each computated milestone rating; and
computating a status report rating for each product development milestone based in part on the computated milestone ratings.

8. A computer-readable medium for monitoring product development, the computer-readable medium having instructions for:
storing an element ratings checklist thereon, the checklist having a number of expectations and a number of product development milestones, each expectation corresponding to a product development milestone;
receiving an expectation rating for each expectation; and
computating a milestone rating for each product development milestone based in part on the received expectation ratings, the milestone ratings for use in rating performance and monitoring product development.

9. The computer-readable medium of claim 8 further comprising instructions for generating a status report having the computated milestone ratings for use in rating performance and monitoring product development.

10. The computer-readable medium of claim 9 further comprising instructions for computating status report ratings for each product development milestone based on the computated milestone ratings and including the status report ratings with the status report.

11. The computer-readable medium of claim 10 further comprising instructions for receiving expectation ratings having red, yellow, or green designations that reflect performance, wherein red reflects a high risk, yellow reflects a moderate risk, and green reflects a low risk.

12. The computer readable medium of claim 11 further comprising instructions for accessing the checklist and the status report for reviewing and editing through a web page.

13. The computer readable medium of claim 12 further comprising instructions for:
storing multiple element rating checklists for a number of elements;
computating milestone ratings for each checklist based in part on received expectation ratings;
generating a status report having each computated milestone rating; and
computating a status report rating for each product development milestone based in part on the computated milestone ratings.

14. A computer system for monitoring product development, the system comprising:
computer means for providing an element ratings checklist having a number of expectations and a number of product development milestones, each expectation corresponding to a product development milestone;
computer means for receiving an expectation rating for each expectation; and
computer means for computating a milestone rating for each product development milestone based in part on the computated expectation ratings, the milestone ratings for use in rating performance and monitoring product development.

15. The system of claim 14 further comprising computer means for generating a status report having the computated milestone ratings for use in rating performance and monitoring product development.

16. The system of claim 15 further comprising computer means for computating a status report rating for each product development milestone based on the computated milestone ratings and means for including the status report ratings with the status report.

17. The system of claim 16 further comprising computer means for accessing the checklist and the status report for reviewing and editing through a web page.

18. The system of claim 17 further comprising:
computer means for providing multiple element rating checklists for a number of elements;
computer means for computating a milestone rating for each checklist based in part on received expectation ratings;
computer means for generating a status report having each computated milestone rating; and
computer means for computating a status report rating for each product development milestone based in part on the computated milestone ratings.
